(19) United States
(12) Patent Application Publication
(10) Pub. No.: US 2007/0185980 A1
(43) Pub. Date: Aug. 9, 2007

(54) Environmentally aware computing devices with automatic policy adjustment features

(75) Inventors: Subil M. Abraham, Plano, TX (US); Tam M. Cao, Trophy Club, TX (US); Adam A. Nemati, Carrollton, TX (US); Mathews Thomas, Flower Mound, TX (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, Armonk, NY (US)

(21) Appl. No.: 11/347,550

(22) Filed: Feb. 3, 2006

(51) Int. Cl. G06F 15/177

(52) U.S. Cl. 709/222; 709/220

(57) ABSTRACT

A method of automatically adjusting device settings can include a step of associating devices with device location beacons and associating users with user location beacons. The devices can be linked to a network that includes a location server. The location server can automatically determine location based relationships between the devices and the users based upon positions of the device location beacons and the user location beacons. For each device, applicable ones of a set of established policies can be determined. For each device, applicable policies can be determined based upon at least one of a physical location of the device, a relative position of the device to the users, and a relative position between the device and other devices. The selected policies can be conveyed to the devices through the network connection. Each device can automatically adjust at least one device setting in accordance with the policies.

### BACKGROUND

1. Field of the Invention

The present invention relates to the field of device automation, and, more particularly, to devices that automatically adjust policies based upon environmental factors.

2. Description of the Related Art

Today's mobile computing devices include numerous configurable settings that can permit the computing devices to operate in a myriad of environments. Many settings appropriate for one environment, however, are extremely inappropriate in another environment. For example, a mobile telephone owner on a fishing excursion can desire to set message and call notification options to generate a relatively loud tone, to ensure that incoming messages are not ignored. The same telephone owner, however, can set their device to vibrate for incoming messages when involved in a meeting or attending a public performance. A silent notification setting can be extremely inappropriate for the fishing excursion and a loud notification setting can be extremely inappropriate for a meeting.

Although the mobile computing devices have the capability to be differentially, these settings require manual attention. Not only must a mobile telephone owner know how to properly operate his/her device, but that owner must also remember to apply the proper settings for the proper environment. Mistakes and/or oversights are invariably made. Thus, mobile devices often ring loudly at inappropriate times, and embarrass absent minded owners.

Other situations exist, where instead of embarrassment at having improper settings, a mobile device user that has not properly adjusted the device for an environment is unable to use the device for its intended purpose. For example, many notebook computers include a wireless network option, which can be used at home, at work, and at various hotspot locations, such as airports or coffee shops. These different locations can require different network settings, user names, and/or passwords. When these configuration parameters are improperly applied, a user is unable to access a network. Even if a user manages to access the network, many network specific settings, such as network drive mappings, printer configurations, and the like still need to be adjusted before the mobile device can be properly utilized.

A conventional solution for this problem is to establish multiple user configurations upon a single device, each configuration being associated with a location where the device is to be used. In one arrangement, different user names can be associated with each location, each user name having corresponding user name specific settings. In another arrangement, one or more profiles can be established, where a profile is a set of device configuration settings associated with a particular environment.

The use of multiple configurations or profiles for a single device requires an initial manual configuration to establish a proper configuration or profile, which is beyond the skill and/or patience of many users. Additionally, once configurations and/or profiles are established, a user must still manually adjust the device from one configuration or profile to another as the device is moved between different environments.

As mobile technologies continue to proliferate, as devices continue to become feature laden, and as people increasingly rely upon computing devices for personal and business purposes, problems associated with devices not being properly adjusted for a particular environment are expected to intensify.

### SUMMARY OF THE INVENTION

The present invention concerns environmentally aware computing devices with automatic policy adjustment features. More specifically, computing devices can be linked to a computing network, which includes at least one location server and at least one policy server. The location server can track a location of computing devices, device users, and networked peripherals. Tracking can be facilitated by associating location beacons with devices and/or the users. Sensors can be deployed to scan and/or locate the location beacons. A policy server can use information from the location server to automatically determine what settings are appropriate for a computing device based upon device location and/or users near the device. As an environment around a computing device changes, device settings can be automatically adjusted.

The present invention can be implemented in accordance with numerous aspects consistent with material presented herein. For example, one aspect of the present invention can include a method of automatically adjusting device settings. The method can include a step of associating devices with device location beacons and associating users with user location beacons. The devices can be linked to a network that includes a location server. The location server can automatically determine location based relationships between the devices and the users based upon positions of the device location beacons and the user location beacons. For each device, applicable ones of a set of established policies can be determined. For each device, applicable policies can be determined based upon at least one of a physical location of the device, a relative position of the device to the users, and a relative position between the device and other devices. The selected policies can be conveyed to the devices through the network connection. Each device can automatically adjust at least one device setting in accordance with the policies.

Another aspect of the present invention can include a method for automatically adjusting device settings in accordance with environmental conditions. The method can identify a device including a device location beacon and a device policy agent. The device can be networked to a location server. The location server can automatically determine a location of the device from the device location beacon. Based upon the determined location, at least one policy for the device can be automatically ascertained. The ascertained policy can be conveyed to the device. The device policy agent can automatically adjust at least one device setting in accordance with the conveyed policy.

Still another aspect of the present invention can include a system for automatically adjusting device settings based upon environmental factors. The system can include a location server, a policy server, and one or more device policy agents. The location server can automatically and dynamically determine locations of devices and users based upon location beacons associated with the devices and users. The policy server can determine environment specific policies for the devices. The policies can be based upon many factors including, but not limited to, a physical location of the devices, a relative distance between the devices, and a relative location of the users to the devices. The device policy agents can each be associated with a particular one of the devices. The policy agents can receive policies determined by the policy server and can responsively adjust device settings in accordance with the policies.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

It should also be noted that the methods detailed herein can also be methods performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system for devices that automatically adjust settings based upon their environment in accordance with an embodiment of the inventive arrangements disclosed herein.

FIG. 2 is a schematic diagram of a system in which user and device locations are dynamically determined and used to configured device settings in accordance with an embodiment of the inventive arrangements disclosed herein.

FIG. 3 is a flow chart of a method for implementing devices that automatically adjust their settings based upon their environment in accordance with an embodiment of the inventive arrangements disclosed herein.

FIG. 4 is a flow chart of a method, where a service agent can configure a system that utilizes environmentally aware devices in accordance with an embodiment of the inventive arrangements disclosed herein.

### DETAILED DESCRIPTION OF THE INVENTION

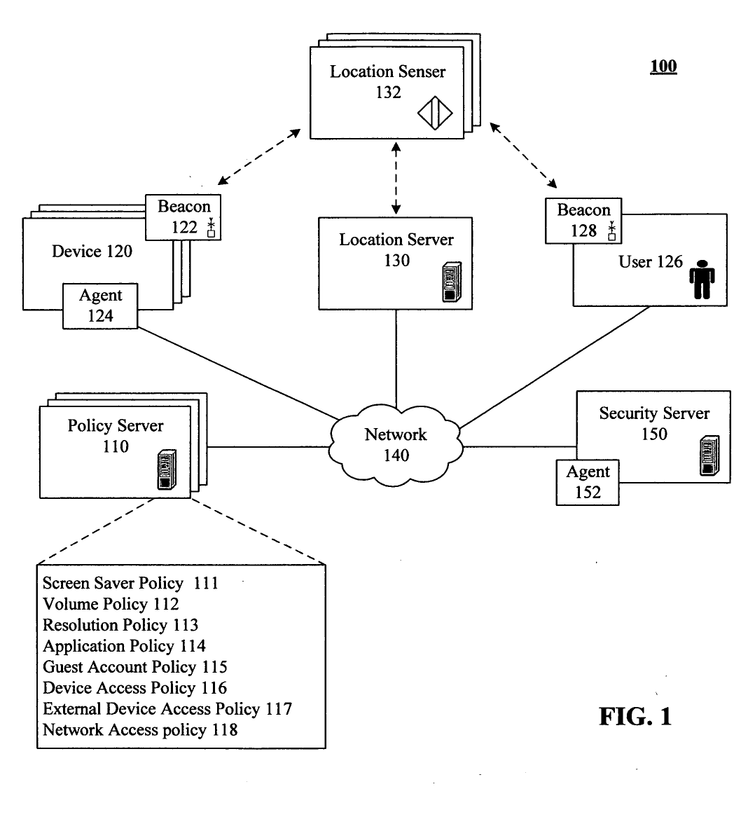

FIG. 1 is a schematic diagram of a system 100 for devices that automatically adjust settings based upon their environment in accordance with an embodiment of the inventive arrangements disclosed herein. In system 100, a device 120 can be aware of where it is located, of nearby devices, and of nearby users 126. Each device 120 can be associated with a device location beacon 122, which is used to by a location server 130 to determine a location for each device 120. Each user 126 can be associated with a user location beacon 128, which can be used by the location server 130 to determine a location for each user 128.

The awareness of each device 120 can be translated into automatic setting adjustments, which are appropriate for a given circumstance in which the device 120 is used. Appropriate settings can be determined from a series of policy driven environment conditions. A device policy agent 124 can interpret a received policy based condition into device specific settings. As the device 120 is moved within an environment, or as conditions of the environment about the device 120 change, the device 120 specific settings can be automatically changed in response.

Device 120 can include any computing device having configurable device settings that is capable of exchanging information via network 140. Device 120 can include relatively fixed computing devices, such as desktop computers, servers, fax machines, printers, video projectors, sound systems, and the like. Device 120 can also include mobile computing devices, such as mobile telephones, tablet computers, personal data assistants (PDAs), digital media players, and the like.

Beacons 122 and 128 can include passive and active mechanisms used to ascertain locations and/or information about an associated device 120 or user 126. One or more location sensors 132 can be used in conjunction with the beacons 122 and 128. Accordingly, beacons 122 and/or 128 can include RFID tags, GPS transceivers, BLUETOOTH transceivers, and other such devices.

For example, the beacon 128 can include an RFID tag embedded within a device commonly carried by user 126, such as a user's name tag, a parking pass, a keychain, a wallet card, a driver's license, and the like. RFID scanners (location sensor 132) can be strategically positioned so that locations of user 126 carried RFID tags can be automatically determined. Additionally, information embedded within the RFID tags can be used to specify data about the associated device 120 or user 126. In most contained environments, such as an office, use of RFID tags and scanners are sufficient to accurately and cost efficiently monitor user 126 and device 120 locations.

The use of other types of beacons 122 is contemplated herein. For example, a short distance transceiver can be used as a beacon 122. Short distance transceivers include BLUETOOTH transceivers, cellular transceivers, and wireless network transceivers (802.11 compliant protocols). Location scanners 132 can include BLUETOOTH servers, cellular towers, wireless access points, and the like. A distance of a beacon 122 to an access point can be determined based upon signal strength. A position of the beacon 122 can be triangulated based upon wireless signals received from multiple sensors 132. Short distance transceiver location determination can be particularly useful in relatively large environments having a relatively sparse user density.

When triangulation is used to determine beacon 122 location, location accuracy and precision can be enhanced by additional environmental input. For example, a location determination of a user 126 can be enhanced using video camera feedback of captured user 126 images. Additionally, a mobile device 122 including GPS components can be queried for precise location information.

Location server 130 can be a computing device that constantly tracks the locations of devices 120 and users 126. The location server 130 can include a grid of a building or other environment, which includes environmental information, such as staircases, walls, doors, and windows. Using location server 130, users 126 and devices 120 can be mapped to their respective locations within the grid.

Security server 150 can be responsible for user authentication, authorization, and access control. Consequently, security server 150 can ensure that only authorized users are able to access network 140. Security server 150 can also determine which users 126 are authorized to access which devices 120. Network agent 152 can be used to automatically adjust a user's or devices privileges based upon environmental conditions.

For example, the network agent 152 can selectively enable/disable network ports. The network agent can also permit/deny device 120 to access to a network service, device, or file. The network agent 152 can require an encryption code from the device 120 before secure communications between the device 120 and network 140 are permitted.

Policy server 110 can be responsible for pushing corporate policies to device agents 124 to which those policies apply. Different triggering conditions and events can be programmed within the policy server 110 to determine settings for each policy. Triggering conditions can depend upon device 120 specific and user 126 specific information. For example, different policies can be selectively applied to mobile phones, which are not applied to PDAs. Additionally, different policy specific events can be triggered by the presence of employees than those triggered by the presence of customers. In one embodiment, device 120 or user 126 specific information can be read from RFID tags (beacons 122 and/or 128) associated with the device 120 or user 128.

Policies supported by policy server 110 can include, but are not limited to, a screen saver policy 111, a volume policy 112, a resolution policy 113, an application policy 114, a guest account policy 115, a device access policy 116, an external device access policy 117, and a network access policy 118.

The screen saver policy 111 can determine a time-out period and saver password enablement state for a policy receiving device 120. For example, a screen saver policy 111 can set a low time out period and require a password when a company laptop is located in an insecure area, such as a company cafeteria. When the same laptop is docked to a user's work area, the screen saver policy 111 can set a high time out period and can disable the password requirement. In another example, a screen saver policy for a conference room can be set to medium time out period by default, which can be automatically adjusted to a low time out period when a user 126 identified as a potential security threat approaches the conference room.

The volume policy 112 can determine an audio volume setting for a policy receiving device 120. For example, the volume policy 112 can automatically turn off the incoming message volume of all mobile telephones entering a conference room. After working hours, the volume policy 112 can adjust a radio volume from low to moderate in an area containing employees known to prefer to work with background music.

The resolution policy 113 can determine a display setting for a policy receiving device 120. The resolution policy 113 can automatically adjust a display for an appropriate video resolution, contrast, or brightness for different environmental conditions. For example, when a device 120 is indoors, display contrast can be set to low and display brightness to medium in accordance with the resolution policy 113. The resolution policy 113 can specify that when the device is outdoors, brightness can be set to low and contrast to high. A special resolution policy 113 can be established for dark auditoriums, where mobile device screens can be automatically turned off, so as not to distract other audience members.

The application policy 114 can perform an application action based upon an environment in which a policy receiving device 120 is currently located. Application actions can include automatically launching an application on the policy receiving device, disabling an application on the policy receiving device 120, and issuing a warning for an active application of the policy receiving device 120. For example, policy 114 can automatically disable an instant messaging application, whenever a user is attending an executive briefing. In another example, policy 114 can automatically activate briefing software linked to a meeting room computer and can load a suitable briefing file in anticipation of a meeting related to the briefing.

In still another example, the application policy 114 can be used to prevent any application other than a designated test taking application from being run on a computing device 120 located in a particular room (such as a class room) at a particular time (a time of a test).

The guest account policy 115 can determine whether existing user accounts on a policy receiving device 120 are usable for an environment in which the receiving device 120 is currently located. That is, many users create guest accounts that permit other users to physically access their system. The guest account policy 115 can selectively enable/disable these guest accounts depending upon whether the device 120 is located in a secure area, contains confidential information, or is accessing a secure network.

The device access policy 116 can selectively activate/deactivate a policy receiving device 120. For example, a PDA (device 120) may be shared by several users in a retail environment. To lesson the danger of the PDA being stolen or used for unauthorized purposes, a company can establish a policy that the PDA is not usable outside the confines of the retail environment. The device policy agent 124 on the PDA can cause the PDA to shut down if usage is attempted from outside the retail environment.

The external device access policy 117 can automatically install a peripheral driver within a storage space of a policy receiving device. For example, the external device access policy 117 can automatically install drivers for printers, fax machines, scanners, and the like upon device 120. Policy 117 can further automatically map network drives suitable for a device's current location and user to a file management program of device 120. The external device access policy 117 can also set a default output for device 120 to a particular network device. Consequently, printed output sent to a default printer can automatically be produced by a printer proximate to the device 120.

The network access policy 118 can determine or alter network settings affecting policy receiving device 120. The network access policy 118 can selectively enable/disable a network access port. The network access policy 118 can require that an encryption key be passed between network agent 152 and device agent 124 before access to network 140 is granted. Network access policy 118 can also be used to selectively enable/disable particular network services for device 120.

Further, network access policy 118 can establish a Web access restriction policy, such as not permitting access to adult sites to a particular user and/or device while that device is in a designated environment. Network access policy 118 can similarly establish an emailing policy, an instant messaging policy, and an online chat policy for a device 120.

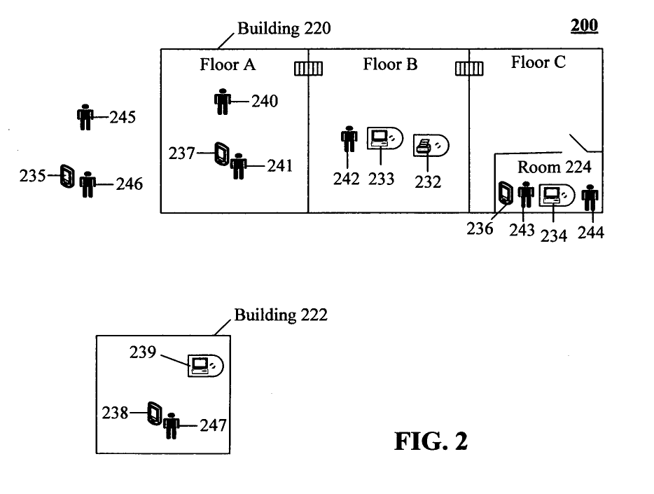

FIG. 2 is a schematic diagram of a system 200 in which user and device locations are dynamically determined and used to configure device settings. System 200 represents one configuration in which environmentally aware devices which automatically configure themselves can be utilized. Components described in system 100 can be used to permit the devices and users shown in system 200 to be automatically detected. Components described in system 100 can also be used to automatically adjust the settings of devices shown in system 200.

System 200 includes a building 222 and a building 220. Building 222 can include person 247, mobile device 238 (phone), and fixed device 239 (computer).

Building 220 can include three floors; floors A, B, and C. Floor C can include room 224. Floor A can include person 240, person 241, and mobile device 237 (phone). Floor B can include person 242, and fixed device 232 (computer) and fixed device 233 (printer). Floor C can include person 243, person 244, fixed device 234 (computer) and mobile device 236 (phone). Person 245, person 246, and mobile device 235 (PDA) can be outside both buildings.

It is assumed that each of the devices 232-339 are communicatively linked to a network to which a policy server (not shown) and a location server (not shown) are linked. It is also assumed that each of the devices 232-239 and persons 240-247 are equipped with location beacons that permit the location server to track their locations. When polices are determined for device not linked to a network, those policies can be queued and automatically transmitted to the devices when a network connection is made.

Turning to system 200 to illustrate various policy examples, a screen saver policy can disable the screen saver on device 233, which is being used by user 242. The same screen saver policy can cause a screen saver with a password lock to be initialized upon device 239, when unauthorized user 247 is the only user in building 222. An application policy can further disable all other applications from being run on device 239, which includes an application that logs a user into a network. Thus, user 247 would not be able to even attempt to log onto computer 239, when not permitted to do so by combined settings of a screen saver policy and an application policy.

A volume policy can enable audible notifications for incoming calls for device 237 located on floor A, but can disable audible call notifications for device 236, while device 236 is in room 224 and while a meeting is being conducted in room 224.

A resolution policy can automatically set a display screen of device 235 for outdoor viewing, while automatically setting a display screen for device 237 for indoor viewing. When user 246 carries device 235 into building 220, the screen settings of device 235 can be automatically adjusted for indoor viewing.

A guest policy can enable guest 244 to logon device 234, while authorized user 243 is present in room 224, but disable guest accounts, when no authorized user is present in room 224 with guests 244. A time out period can be established, where guest 244 can continue to use a guest account on device 234 for up to ten minutes after an authorized user leaves the room.

A device access policy can enable device 235 when used within four hundred meters of building 220, but disable the device 235 when it is located more than four hundred meters from building 220. Similarly, a device access policy can disable device 239, when no authorized users are detected within building 222.

An external device access policy can automatically establish printer 232 as a default printer for device 233. If device 233 is moved to floor A, a different printer (not shown) could be automatically established as a default printer in accordance with an external device access policy that favors proximity for a default printer. An external device access policy can also automatically establish printer 232 as a default printer for devices 236 and 237, when those devices are located in building 220. Appropriate drivers can be automatically loaded onto devices 236 and 237 to enable the devices to use printer 233.

A network access policy can restrict file access to device 234 to those files that both user 243 and 244 are authorized, while user 243 and user 244 are both present in room 224. Network access policy can also only permit a user to successfully log onto device 233 using a valid user id and password, when user 242 associated with the user id is present on floor B. Otherwise, network access can be denied even though a valid user id and password were provided. This enhanced security policy can be enabled during weekend hours and disabled during weekday work hours, when other users are present in building 220.

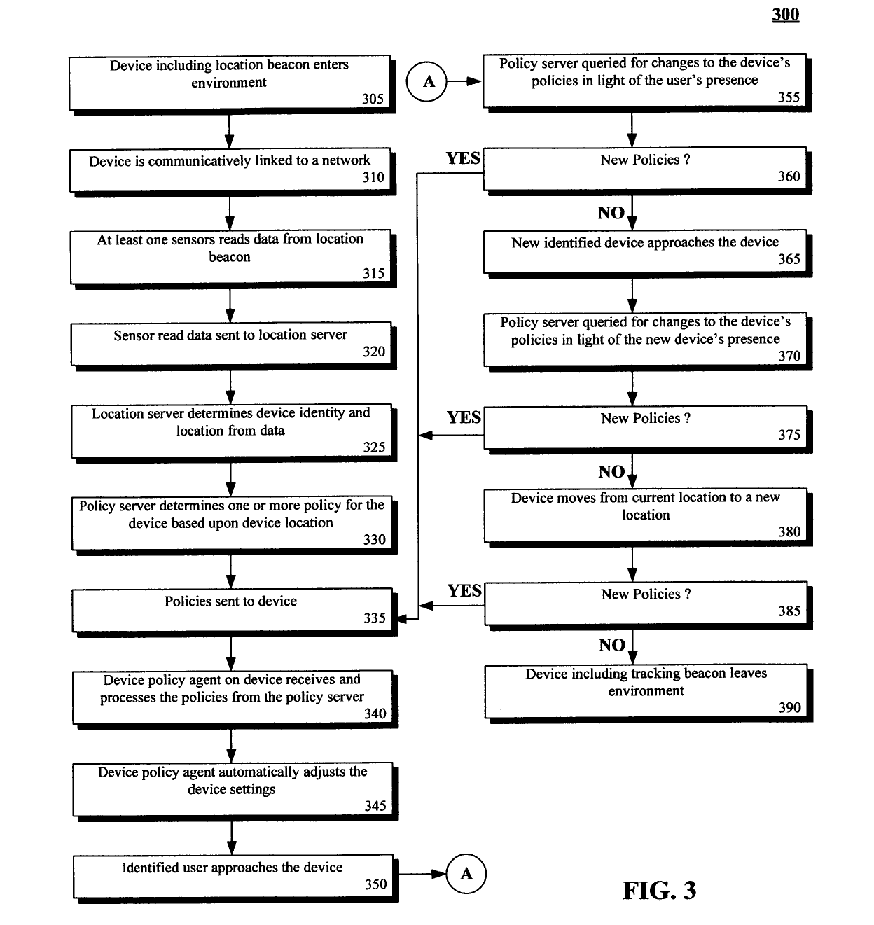

FIG. 3 is a flow chart of a method 300 for implementing devices that automatically adjust their settings based upon their environment in accordance with an embodiment of the inventive arrangements disclosed herein. Method 300 can be performed in the context of system 100 and/or system 200.

Method 300 can begin in step 305, where a device that includes a location beacon enters an aware environment managed by a location and policy server. In step 310, the device can be communicatively linked to a network. If the device is not linked, policies for the device can be stored in a network storage space until the device is connected to the network. In step 315, at least one sensor can read data from the location beacon. In one embodiment, the location beacon can be a RFID tag and the location sensor can be a RFID tag scanner. In step 320, the data gathered by the sensor can be sent to a location server.

In step 325, the location server can determine the device identity and location. For example, the sensor data can indicate that the device is a mobile phone having internet capabilities, a phone number 123-4567, and is owned by Mr. Smith. In step 330, a policy server can determine one or more policy for the device based upon device location. For example, one policy for the device can be a network access policy that permits contact information to be automatically synchronized between the device and a contact server connected to the network.

In step 335, the policies can be sent to the device. In step 340, the device policy agent on the device can receive and process the policies. In step 345, the policy agent can automatically adjust device settings in compliance with the policies. For example, the device can automatically transmit user access information to log onto the contact server and begin synchronization in accordance with the network access policy. The device agent can be automatically provided with any information needed to implement the policy in step 340.

In step 350, the location server can detect a user approaching the mobile device. In step 355, a policy server can be queried for changes to the device's policies in light of the user's presence. In step 360, a determination can be made if any new policies are to be implemented for the device. If so, the method can loop from step 360 to step 335, where the new policies can be sent to the device. For example, a volume policy can restrict the mobile phone to medium, low, or off volume levels, whenever another user is nearby. The device policy engine can automatically alter device settings in accordance with the new policy.

If no new policies are determined in step 360, the method can proceed to step 365, where the location server can determine that a new device is approaching the mobile phone. For example another mobile telephone can be carried near the mobile phone. In step 370, the policy server can be queried for changes to the device's policies in light of the new device's presence. In step 375, a determination can be made if any new policies are to be implemented for the device. If so, the method can loop to step 335. If not, the method can proceed to step 380.

In step 380, the location server can determine that the device is moved from its current location to a new location. In step 385, a determination can be made if any new policies are to be implemented for the device. If so, the method can loop to step 335. If not, the method can continue to step 390. In step 390, the device can be moved outside the area managed by the location and policy server.

It should be appreciated that a different location and/or policy server can be present in the new area, in which case, the method can loop back to step 305, where details for the steps 305-385 are handled in accordance with settings established for the new area.

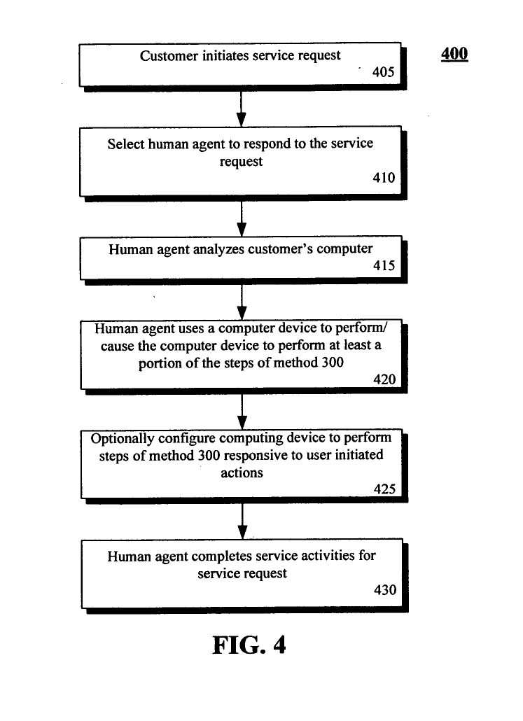

FIG. 4 is a flow chart of a method 400, where a service agent can configure a system that utilizes environmentally aware devices in accordance with an embodiment of the inventive arrangements disclosed herein. Method 400 can be preformed in the context of system 100 and/or 200.

Method 400 can begin in step 405, when a customer initiates a service request. The service request can be a request for a service agent to convert a legacy system or network into a system having environmental awareness. The service request can also be a request to troubleshoot a problem with a policy setting system. Additionally, the request can be for an enhancement of an existing location determination system, such as a request to enhance an existing system to include more accurate user or device location detection components.

In step 410, a human agent can be selected to respond to the service request. In step 415, the human agent can analyze a customer's current system and can develop a solution. The solution can include the acquisition and deployment of additional hardware, such as location beacons and location sensors.

In step 420, the human agent can use one or more computing devices to perform or to cause the computer device to perform the steps of method 300. In optional step 425, the human agent can configure the customer's computer in a manner that the customer or clients of the customer can perform one or more steps of method 400 in the future. For example, the service agent can load and configure software and hardware so that user devices will automatically adjust setting in accordance with established policies. In step 430, the human agent can complete the service activities.

It should be noted that while the human agent may physically travel to a location local to adjust the customer's computer or application server, physical travel may be unnecessary. For example, the human agent can use a remote agent to remotely manipulate the customer's computer system and/or an application server.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method of automatically adjusting device settings comprising:
associating a plurality of devices with a plurality of device location beacons, wherein at least a portion of the devices are mobile devices;
associating a plurality of users with a plurality of user location beacons;
communicatively linking the plurality of devices to a network that includes a location server;
the location server automatically determining location based relationships between the devices and the users based upon positions of the device location beacons and the user location beacons;
for each device, selecting applicable ones of a plurality of policies, wherein for each device, applicable policies are determined based upon at least one of a physical location of the device, a relative position of the device to the users, and a relative position between the device and other devices;
automatically conveying the selected policies to each device; and
responsive to receiving the policies, each device automatically adjusting at least one device setting in accordance with the policies.

2. The method of claim 1, wherein the policies include at least one of a screen saver policy, and a volume policy, wherein the screen saver policy determines a time-out period and saver password enablement state for a policy receiving device, and wherein the volume policy determines an audio volume setting for a policy receiving device.

3. The method of claim 1, wherein the policies include at least one of a resolution policy, and an external device access policy, wherein the resolution policy determines a display setting for a policy receiving device, and wherein the external device access policy automatically installs a peripheral driver within a storage space of a policy receiving device.

4. The method of claim 1, wherein the policies include at least one of an application policy, and a device access policy, wherein the application policy is to perform an application action based upon an environment in which a policy receiving device is currently located, and wherein the device access policy selectively alters an activation state of a policy receiving device, said application actions including at least one action from a group consisting of automatically launching an application on the policy receiving device, disabling an application on the policy receiving device, and issuing a warning for an active application executing on the policy receiving device.

5. The method of claim 1, wherein the policies include at least one of a guest account policy, and a network access policy, wherein the guest account policy determines whether existing user accounts on a policy receiving device are usable for an environment in which the receiving device is currently located, and wherein the network access policy that determines at least one of network ports and network servers that the devices receiving the policies are able to utilize.

6. The method of claim 1, wherein said steps of claim 1 are performed by at least one machine in accordance with at least one computer program having a plurality of code sections that are executable by the at least one machine.

7. A method for automatically adjusting device settings in accordance with environmental conditions comprising:
identifying a device comprising a device location beacon and a device policy agent;
networking the device to a location server;
the location server automatically determining a location of the device from the device location beacon;
based upon the determined location, automatically ascertaining at least one policy to implement upon the device;
conveying the ascertained policy to the device; and
the device policy agent automatically adjusting at least one device setting in accordance with the conveyed policy.

8. The method of claim 7, further comprising:
the location server automatically determining a change in the location of the device from the device location beacon;
based upon the change, automatically ascertaining a new policy for the device;
conveying the new policy to the device; and
the device policy agent automatically adjusting at least one device setting in accordance with the new policy.

9. The method of claim 7, further comprising:
associating a user location beacon with a user;
the location server automatically determining a location of the user from the user location beacon;
based upon the determined location relative to the location of the device, automatically ascertaining a new policy for the device;
conveying the new policy to the device; and
the device policy agent automatically adjusting at least one device setting in accordance with the new policy.

10. The method of claim 9, wherein the user is utilizing the device to access a network, wherein the new policy is a security policy that requires a user identifier used to access the network to correspond to the user.

11. The method of claim 9, wherein the device is configured to be used by a plurality of different users, each user having user specific settings, wherein the new policy causes the device policy agent to adjust the device settings for the user specific settings associated with the user.

12. The method of claim 7, wherein the device is a first device, wherein the device location beacon is a first device location beacon, and wherein the device policy agent is a first device policy agent, said method further comprising:
identifying a second device comprising a second device location beacon and a second device policy agent;
networking the second device to the remotely located location server;
the location server automatically determining a location of the second device from the second device location beacon;
based upon the locations of the first device and the second device, automatically ascertaining a first policy for the first device and a second policy for the second device, wherein the first policy is the ascertained policy of the conveying step;
conveying the second policy to the second device; and
the second device policy agent automatically adjusting at least one device setting in accordance with the second policy, wherein the first policy and the second policy are based upon a proximity of the first device to the second device.

13. The method of claim 7, further comprising:
the location server determining a new device is located within a previously determined distance from the device;
based upon the location of the new device, initializing at least one new policy; and
conveying the new policy to the device policy agent, wherein responsive to the new policy data is automatically exchanged between the device and the new device.

14. The method of claim 7, wherein said steps of claim 7 are performed by at least one machine in accordance with at least one computer program having a plurality of code sections that are executable by the at least one machine.

15. The method of claim 7, wherein the steps of claim 7 are performed by at least one of a service agent and a computing device manipulated by the service agent, the steps being performed in response to a service request.

16. A system for automatically adjusting device settings based upon environmental factors comprising:
a location server configured to automatically and dynamically determine locations of a plurality of devices and a plurality of users based upon location beacons associated with the devices and users;
a policy server configured to determine a plurality of environment specific policies for the plurality of devices, wherein the policies are based upon a plurality of factors, wherein the factors include a physical location of the devices, a relative distance between the devices, and a relative location of the users to the devices; and
a plurality of device policy agents, each associated with a particular one of the devices, wherein the policy agents receive policies determined by the policy server and responsively adjust device settings in accordance with the policies.

17. The system of claim 16, wherein the location server dynamically updates the locations of the devices and users, wherein the policy server dynamically updates policies based upon location server determined information, and wherein the device policy agents automatically receive policy updates from the policy server and responsively adjust device settings in accordance with the updated policies.

18. The system of claim 16, wherein the environment specific policies includes at least one of a network policy, an guest account policy, and a device access policy, wherein the network access policy that determines at least one of network ports and network servers that the devices receiving the policies are able to utilize, wherein the guest account policy determines whether existing user accounts on a policy receiving device are usable for an environment in which the receiving device is currently located, and wherein the device access policy selectively alters an activation state of a policy receiving device.

19. The system of claim 16, wherein the environment specific policies includes at least one of an external device access policy and an application policy, wherein the external device access policy automatically installs a peripheral driver within a storage space of a policy receiving device, and wherein the application policy is to perform an application action based upon an environment in which a policy receiving device is currently located, and wherein the device access policy selectively activates a policy receiving device whose default activate state is set for a non-activated mode, said application actions including at least one action from a group consisting of automatically launching an application on the policy receiving device, disabling an application on the policy receiving device, and issuing a warning for an active application executing on the policy receiving device.

20. The system of claim 16, wherein the environment specific policies includes at least one of a screen saver policy, a volume policy, and a resolution policy, wherein the screen saver policy determines a time-out period and saver password enablement state for a policy receiving device, wherein the volume policy determines an audio volume setting for a policy receiving device, and wherein the resolution policy determines a display setting for a policy receiving device, and wherein the external device access policy automatically installs a peripheral driver within a storage space of a policy receiving device.
